(19) United States
(12) Patent Application Publication
(10) Pub. No.: US 2015/0312492 A1
(43) Pub. Date: Oct. 29, 2015

(54) IMAGE DATA PROCESSING DEVICE HAVING IMAGE SENSOR WITH SKEWED PIXEL STRUCTURE

(71) Applicant: SAMSUNG ELECTRONICS CO., LTD., Suwon-si (KR)

(72) Inventor: Min Ho KIM, Seongnam-si (KR)

(73) Assignee: SAMSUNG ELECTRONICS CO., LTD., Suwon-si (KP)

(21) Appl. No.: 14/612,900

(22) Filed: Feb. 3, 2015

(30) Foreign Application Priority Data
Apr. 24, 2014 (KR) 10-2014-0049554

(51) Int. Cl. H04N 5/349; H04N 5/374; H04N 5/378

(52) U.S. Cl. CPC H04N 5/349; H04N 5/378; H04N 5/374

(57) ABSTRACT

An image data processing device includes an image sensor which includes a first pixel disposed in a first layer and a second pixel which is disposed in a second layer and is partially overlapped with the first pixel to form an overlapped area, and is configured to output a first signal from the first pixel and a second signal from the second pixel; and an image signal processor configured to output a first data for the overlapped area using a ratio for the overlapped area between the first pixel and the second pixel and the first signal, and output a second data for the overlapped area using the ratio and the second signal.

### CROSS-REFERENCE TO RELATED APPLICATION

This application claims priority from Korean Patent Application No. 10-2014-0049554 filed on Apr. 24, 2014, the disclosure of which is hereby incorporated by reference in its entirety.

### BACKGROUND

Apparatuses and methods consistent with exemplary embodiments relate to an image data processing device, and more particularly to an image data processing device which may generate a high resolution image which looks like a high resolution image having a reduced size of a pixel without actually reducing a size of the pixel according to a position where a pixel electrode is embodied.

As a resolution of a CMOS image sensor increases, a size of a pixel included in an active pixel array has to be decreased.

As the size of the pixel is decreased, a photoelectric conversion element, e.g., a photodiode, included in the pixel is decreased in size and it is difficult to ensure a space to embody a readout circuit for reading an output signal of the photoelectric conversion element. Moreover, as a light-receiving area of the photoelectric conversion element becomes smaller, electric charges corresponding to incident light are hardly generated.

When the electric charges are hardly generated or the number of the electric charges is small, a CMOS image sensor might not accurately convert an optical image into electric signals. Accordingly, a performance of the CMOS image sensor may be lowered.

### SUMMARY

Exemplary embodiments may address at least the above problems and/or disadvantages and other disadvantages not described above. Also, the exemplary embodiments are not required to overcome the disadvantages described above, and may not overcome any of the problems described above.

One or more exemplary embodiments provide an image sensor which may generate a high resolution image which looks like a high resolution image having a reduced size of a pixel without actually reducing a size of the pixel.

One or more exemplary embodiments provide an image data processing device which may generate and process RGB data from output signals output from the image sensor.

According to an aspect of an exemplary embodiment, there is provided an image data processing device including an image sensor and an image signal processor which processes a first signal and a second signal output from the image sensor. The image sensor includes a first pixel embodied in a first layer, and a second pixel which is embodied in a second layer and is partially overlapped with the first pixel. The image signal processor outputs first data for the overlapped area using a ratio for an overlapped area between the first pixel and the second pixel, and the first signal output from the first pixel, and outputs second data for the overlapped area using the ratio and the second signal output from the second pixel.

When the image sensor further outputs a third signal and a fourth signal output from each of a third pixel and a fourth pixel included in the first layer, the image signal processor which processes the third signal and the fourth signal outputs third data for the overlapped area using a function of a first value generated by the ratio and the third signal and a second value generated by the ratio and the fourth signal.

Each of the third pixel and the fourth pixel is partially overlapped with the second pixel. The function may be an average value.

By using a reference ratio of a reference overlapped area between the first pixel and the second pixel and the ratio, the image signal processor may correct each of the first data, the second data, and the third data to be the reference ratio.

The image sensor includes a correlated double sampling circuit which performs correlated double sampling on the first signal to the fourth signal, adjusts each gain of the first signal to the fourth signal using the ratio, and outputs each of the first to fourth signals whose gains are adjusted to the image signal processor.

The first pixel is a blue pixel, the second pixel is an organic green pixel, and the third pixel and the fourth pixel are red pixels.

The second pixel includes a first photo-electric conversion region of an organic material, a first pixel electrode which is partially overlapped with each of the first pixel to the third pixel, and collects electric charges generated in the first photo-electric conversion region, and a common electrode which supplies a bias voltage to the firs photo-electric conversion region.

According to an aspect of an exemplary embodiment, there is provided an image data processing device including an image sensor, and an image signal processor which processes a first signal, a second signal, and a third signal output from the image sensor. The image sensor includes a first pixel embodied in a first layer, a second pixel which is embodied in a second layer and is partially overlapped with the first pixel, and a third pixel which is embodied in a third layer and is partially overlapped with each of the first pixel and the second pixel.

The image signal processor outputs first data for the overlapped area by using a ratio for an overlapped area among the first pixel to the third pixel, and the first signal output from the first pixel, outputs second data for the overlapped area by using the ratio and the second signal output from the second pixel, and outputs third data for the overlapped area by using the ratio and the third signal output from the third pixel.

Each of the first pixel to the third pixel may be an organic pixel.

A portable electronic device according to an exemplary embodiment includes an image sensor, and an application processor which includes an image signal processor processing a first signal and a second signal output from the image sensor. The image sensor includes a first pixel embodied in a first layer and a second pixel which is embodied in the second layer and is partially overlapped with the first pixel.

The image signal processor outputs first data for the overlapped area by using a ratio for an overlapped area between the first pixel and the second pixel and the first signal output from the first pixel, and outputs second data for the overlapped area by using the ratio and the second signal output from the second pixel.

### BRIEF DESCRIPTION OF THE DRAWINGS

The above and/or other aspects will become more apparent by describing certain exemplary embodiments with reference to the accompanying drawings, in which:

FIGS. 1A and 1B are conceptual diagrams for describing a structure of image sensors according to an exemplary embodiment;

FIGS. 2, 3, and 4 conceptually show structures of an image sensor according to an exemplary embodiment;

FIG. 5 is a cross-sectional view of the image sensor of FIG. 2 embodied in a front side illumination (FSI) method, which is taken along line V-V′;

FIG. 6A is a top view of a green pixel and a red pixel which are partially overlapped with each other;

FIG. 6B is a top view of the green pixel and a blue pixel which are partially overlapped with each other;

FIG. 7 is a detailed diagram of a semiconductor substrate and a circuit region illustrated in FIG. 5;

FIG. 8 is a cross-sectional view of the image sensor of FIG. 2 embodied in a back side illumination (BSI) method, which is taken along line V-V′;

FIGS. 9A and 9B illustrate a readout circuit according to an exemplary embodiment;

FIGS. 10A and 10B illustrate the readout circuit according to an exemplary embodiment;

FIGS. 11A and 11B are flowcharts of a method of manufacturing an image sensor according to an exemplary embodiment;

FIG. 12 is a block diagram of an image data processing device according to an exemplary embodiment;

FIG. 13 is a flowchart of an operation of an image signal processor according to an exemplary embodiment;

FIG. 14 shows a correlated double sampling circuit according to an exemplary embodiment;

FIG. 15 is a block diagram of a portable electronic device according to an exemplary embodiment;

FIG. 16 is a schematic cross-sectional view of an image sensor including three stacked organic pixels according to an exemplary embodiment; and

FIG. 17 is a conceptual diagram of a process of processing output signals of the three stacked organic pixels according to an exemplary embodiment.

### DETAILED DESCRIPTIONS

Certain exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail since they would obscure the description with unnecessary detail.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

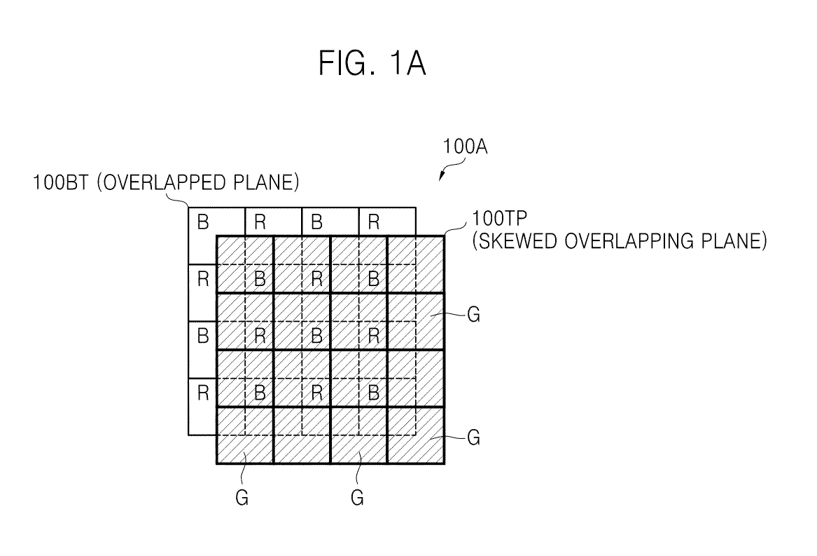

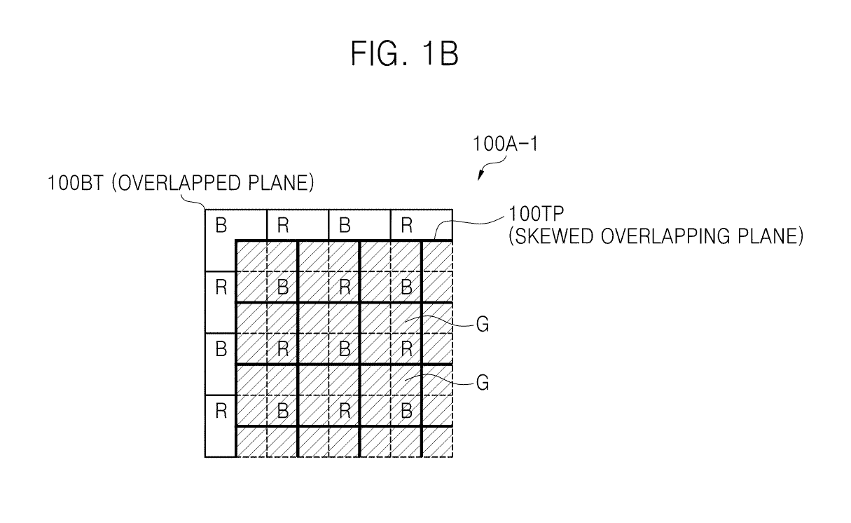

FIGS. 1A and 1B are conceptual diagrams for describing a structure of image sensors according to an exemplary embodiment. Referring to FIG. 1A, an image sensor 100A, for example, a pixel array, includes a first layer 100BT including a plurality of blue pixels B and red pixels R, and a second layer 100TP including a plurality of green pixels G.

The second layer 100TP is partially overlapped with a first layer 100BT on or over the first layer 100BT, and is moved in a given direction, for example, x-axis direction, y-axis direction, a diagonal direction, or the like, on a basis of a left vertex of the first layer 100BT. The image sensor 100A having such a structure may be referred to as an organic image sensor having a skew pixel structure.

The first layer 100BT may be referred to as an overlapped plane, and the second layer 100TP may be referred to as an overlapping plane.

Each of the plurality of green pixels G is partially overlapped with each of pixels among the plurality of blue pixels B and red pixels R arranged in a n×m array (n=m or n≠m). When n equals to m, n may be a natural number larger than 1, for example, 2. Here, “R” represents a red pixel which may generate an electric signal corresponding to red wavelengths or a red color range, “B” represents a blue pixel which may generate an electric signal corresponding to blue wavelengths or a blue color range, and “G” represents a green pixel which may generate an electric signal corresponding to green wavelengths or a green color range.

As illustrated in FIG. 1B, an image sensor 100A-1, for example, a pixel array, includes the first layer 100BT and the second layer 100TP which are stacked with each other. As illustrated in FIG. 1B, an edge portion of the second layer 100TP which is not overlapped with the first layer 100BT is not generated or may be removed as illustrated in FIG. 1B. According to another exemplary embodiment, edge portions of the first layer 100BT and the second layer 100TP which are not overlapped with each other may be removed.

For convenience of description in FIGS. 1A and 1B, it is illustrated that the second layer 100TP includes a plurality of green pixels G, and the first layer 100BT includes a plurality of blue pixels B and red pixels R. However, the second layer 100TP may include a plurality of red pixels R according to an exemplary embodiment, and the first layer 100BT may include a plurality of green pixels G and blue pixels B. According to another exemplary embodiment, an edge portion of the first layer 100BT which is not overlapped with the second layer 100TP is not generated or may be removed. According to another exemplary embodiment, the second layer 100TP includes a plurality of blue pixels B, and the first layer 100BT may include a plurality of red pixels R and green pixels G.

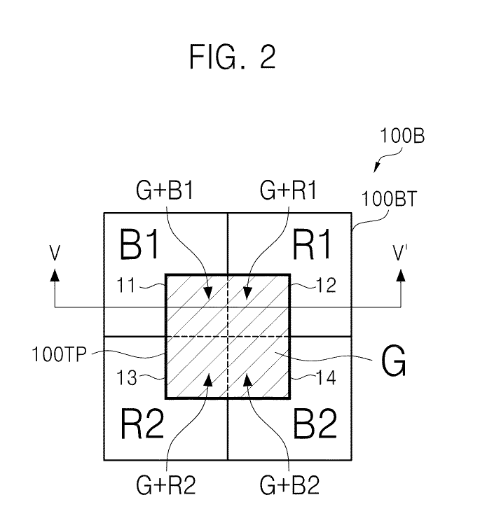

FIGS. 2, 3, and 4 conceptually show structures of an image sensor including a green pixel disposed to be partially overlapped with each of red and/or blue pixels. Referring to FIGS. 1A, 1B, and 2, an image sensor 100B corresponding to a portion of the image sensor 100A includes a 2×2 pixel array including blue pixels B1, B2 and red pixels R1, R2, disposed in the first layer 100BT and a green pixel G arranged in the second layer 100TP.

The plurality of blue pixels and red pixels arranged in the first layer 100BT of FIG. 1A may include 2×2 pixel arrays including pixels B1, R1, R2, and B2 which are repeatedly disposed to overlap a plurality of green pixels G arranged in the second layer 100TP.

Each of the red pixels and blue pixels B1, R1, R2, and B2 of the 2×2 pixel array and a green pixel G are partially overlapped with each other.

Overlapped regions 11, 12, 13 and 14 of the green pixel G partially overlapped with each of the blue or red pixel B1, R1, R2, and B2 may be the same as or different from each other in size. A sum of each size of the overlapped regions 11, 12, 13, and 14 may be the same as or different from a size of the green pixel G.

For example, at least two regions of four overlapped regions 11, 12, 13, and 14 may be of the same size.

A signal corresponding to green wavelengths, i.e., a green region of a visible light, and a signal corresponding to blue wavelengths, i.e., a blue region of visible light, are generated in an overlapped portion 11 of two stacked pixels G and B1. In an overlapped portion 12 of two stacked pixels G and R1, a signal corresponding to green wavelengths and a signal corresponding to red wavelengths, i.e., a red region of visible light, are generated.

In an overlapped portion 13 of two stacked pixels G and R2, a signal corresponding to the green wavelengths and a signal corresponding to the red wavelengths are generated. In an overlapped portion 14 of two stacked pixels G and B2, a signal corresponding to the green wavelengths and a signal corresponding to blue wavelengths are generated.

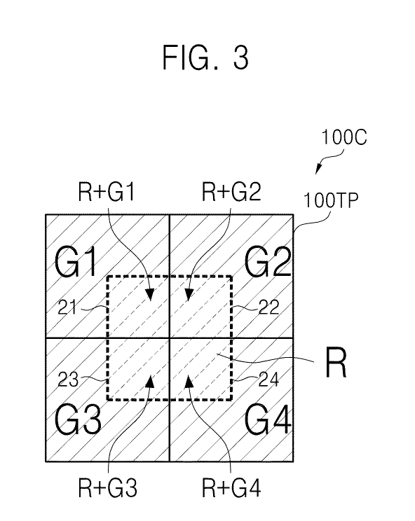

Referring to FIGS. 1A and 3, an image sensor 100C corresponding to a portion of the image sensor 100A includes a red pixel R disposed in the first layer 100BT and a 2×2 pixel array including green pixels G1, G2, G3, and G4 disposed in the second layer 100TP.

A plurality of green pixels arranged in the second layer 100TP include 2×2 pixel arrays including green pixels G1, G2, G3, and G4 which are repeatedly disposed to be overlapped with a plurality of red pixels R disposed in the first layer 100BT.

Each of the green pixels G1, G2, G3, and G4 is partially overlapped with a red pixel R. Overlapped regions 21, 22, 23, and 24 of the green pixels G1, G2, G3, and G4 each partially overlapped with the red pixel R may be the same as or different from each other in size. A sum of the sizes of the overlapped regions 21, 22, 23, and 24 each partially overlapped with the red pixel R may be the same as the size of the red pixel R.

In an overlapped portion 21 of two stacked pixels R and G1, a signal corresponding to red wavelengths and a signal corresponding to green wavelengths are generated. In an overlapped portion 22 of two stacked pixels R and G2, a signal corresponding to red wavelengths and a signal corresponding to green wavelengths are generated.

In an overlapped portion 23 of two stacked pixels R and G3, a signal corresponding to red wavelengths and a signal corresponding to green wavelengths are generated. In an overlapped portion 24 of two stacked pixels R and G4, a signal corresponding to red wavelengths and a signal corresponding to green wavelengths are generated.

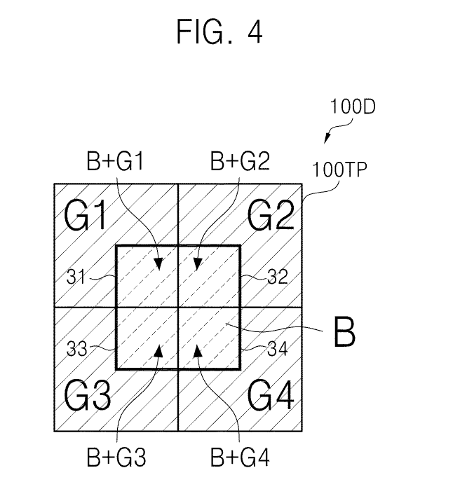

Referring to FIGS. 1A and 4, an image sensor 100D corresponding to a portion of the image sensor 100A includes a blue pixel B disposed in the first layer 100BT and a 2×2 pixel array including green pixels G1, G2, G3, and G4 disposed in the second layer 100TP.

A plurality of green pixels arranged in the second layer 100TP include 2×2 pixel arrays including green pixels G1, G2, G3, and G4 which are repeatedly disposed to be overlapped with blue pixels B disposed in the first layer 100BT.

Each of the green pixels G1, G2, G3, and G4 is partially overlapped with a blue pixel B. A sum of the sizes of the overlapped regions 31, 32, 33, and 34 of each of the green pixels G1, G2, G3, and G4 which are partially overlapped with the blue pixel B may be the same as the size of the blue pixel B.

In an overlapped portion 31 of two stacked pixels B and G1, a signal corresponding to blue wavelengths and a signal corresponding to green wavelengths are generated. In an overlapped portion 32 of two stacked pixels B and G2, a signal corresponding to blue wavelengths and a signal corresponding to green wavelengths are generated.

In an overlapped portion 33 of two stacked pixels B and G3, a signal corresponding to blue wavelengths and a signal corresponding to green wavelengths are generated. In an overlapped portion 34 of two stacked pixels B and G4, a signal corresponding to blue wavelengths and a signal corresponding to green wavelengths are generated.

As described referring to FIGS. 1A to 4, 2×2 pixel arrays are repeatedly disposed in at least one of the first layer 100BT and the second layer 100TP.

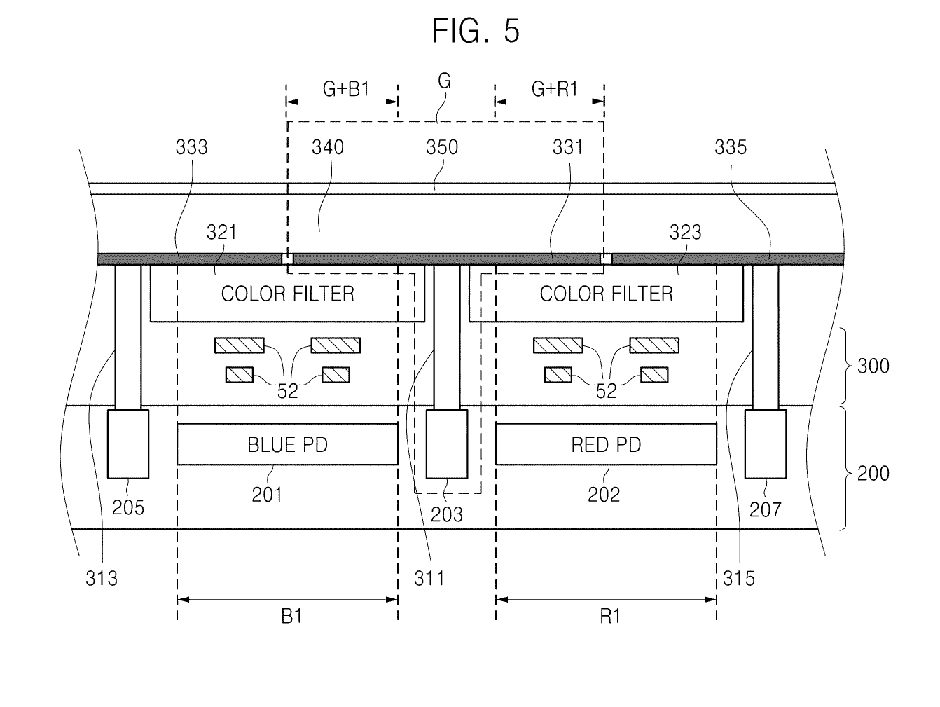

FIG. 5 is a cross-sectional view of the image sensor of FIG. 2 embodied in a front side illumination (FSI) method, which is taken along line V-V′. Referring to FIGS. 1A, 2, and 5, a blue photoelectric conversion region (PD) 201, a red photoelectric conversion region (PD) 202, and a plurality of green storage regions 203, 205, and 207 are formed in a semiconductor substrate 200, which may be formed of a silicon. Each of the plurality of green storage regions 203, 205, and 207 performs a function of accumulating electric charges transferred through each contact plug 311, 313, and 315, which may be formed of metal.

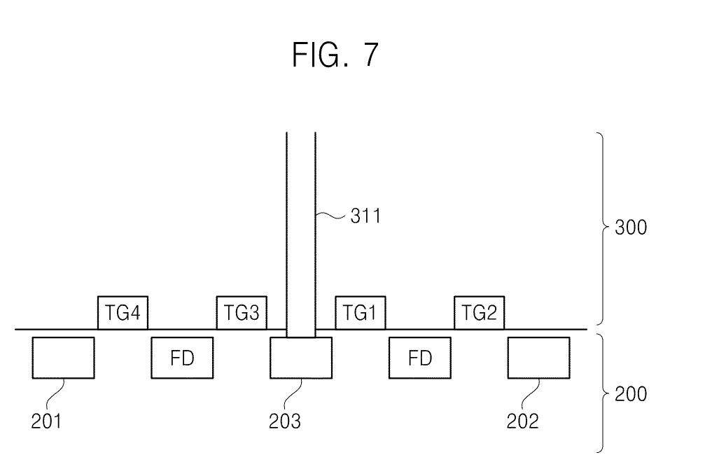

As illustrated in FIGS. 5 and 7, each floating diffusion region (FD) corresponding to each region 201, 202, 203, 205, and 207 may be formed in the semiconductor substrate 200. A circuit region 300 may be formed on or over the semiconductor substrate 200. In the circuit region 300, a gate electrode of each transfer transistor TG1 to TG4 for transferring electric charges accumulated in each region 201, 202, 203, 205, and 207 to each floating diffusion region FD may be embodied. That is, in the circuit region 300, metal interconnects 52 to transfer electric charges accumulated in each region 201, 202, 203, 205, and 207 to a readout circuit are embodied.

Color filters 321 and 323 may be formed on or over the circuit region 300. A blue color filter 321 allows blue wavelengths passing through pixel electrodes 331 and 333 to pass through a blue photoelectric conversion region 201. The blue photoelectric conversion region 201 performs a photoelectric conversion operation based on the blue wavelengths. The pixel electrodes 331 and 333 which are separated from each other are formed on or over the blue color filter 321.

For convenience of description in FIG. 5, it is illustrated that a first length of a first region where a blue color filter 321 and a pixel electrode 331 are overlapped with each other is the same as a second length of a second region where the blue color filter 321 and a pixel electrode 333 are overlapped with each other; however, the first region and the second region may have lengths different from each other according to an exemplary embodiment.

A red color filter 323 allows red wavelengths passing through the pixel electrodes 331 and 335 to pass through the red photoelectric conversion region 202. The red photoelectric conversion region 202 performs a photoelectric conversion operation based on the red wavelengths. The pixel electrodes 331 and 335 which are separated from each other are formed on or over the red color filter 323.

For convenience of description in FIG. 5, it is illustrated that a third length of a third region where the red color filter 323 and the pixel electrode 331 are overlapped with each other is the same as a fourth length of a fourth region where the red color filter 323 and the pixel electrode 335 are overlapped with each other; however, the third region and the fourth region may have different lengths from each other according to an exemplary embodiment. Each of the pixel electrodes 331, 333, and 335 which are separated from each other is formed on each color filter 321 and 323. Thus, the regions of electrodes 331 and 333 and the regions of electrodes 331 and 335 substantially cover respective color filters 321 and 323 with an exception of a gap or gaps.

As illustrated in FIG. 5, a start position of the pixel electrode 331 does not correspond to a start position of each color filter 321 and 323. For example, when a start position of the pixel electrode 331 corresponds to a start position of the color filters 321 on a basis of a vertical line is referred to as a 0% skew, the start position of the pixel electrode 331 illustrated in FIG. 5, which is positioned at about the middle of the color filter 321, has a 50% skew.

The pixel electrode 331 may be moved to a 50% skew based on a pixel pitch. A photoelectric conversion region 340 for the organic material is formed on or over each of the pixel electrodes 331, 333, and 335. For example, the photoelectric conversion region 340 of an organic material performs a photoelectric conversion operation based on green wavelengths, generates electric charges, and allows blue wavelengths and red wavelengths to be passed through.

The photoelectric conversion region 340 of an organic material may include an electron donating organic material and an electric accepting organic material. For example, a first organic layer may be formed on or above each of the pixel electrodes 331, 333, and 335, and a second organic layer may be formed on or over the first organic layer.

When the first organic layer is formed to be a layer including one of the electron donating organic material and the electron accepting organic material, the second organic layer may be formed to include the other one of the electron donating organic material and the electron accepting organic material. For example, the first organic layer may be an n-type organic material, and the second organic layer may be the p-type organic material, of the p-type organic material and the n-type organic material. Accordingly, the first organic layer and the second organic layer may form a p-n junction.

Here, the electron donating organic material is a material which may generate a donor ion in response to light, and the electron accepting organic material is a material which may generate an acceptor ion in response to the light. According to another exemplary embodiment, the photoelectric conversion region 340 of an organic material may be an organic material in which the electron donating organic material and the electron accepting organic material are mixed.

Each of the pixel electrodes 331, 333, and 335 performs a function of collecting electric charges generated based on green wavelengths in the photoelectric conversion region 340 of an organic material and a function of allowing blue wavelengths and red wavelengths to be passed through. Each of the pixel electrodes 331, 333, and 335 may be embodied in a transparent electrode. For example, each of the pixel electrodes 331, 333, and 335 may be embodied in zinc oxide (ZnO) or Indium tin oxide or tin-doped indium oxide (ITO). Each of pixel electrodes 331, 333, and 335 may be embodied in a pixel electrode film. Electric charges collected by each of the pixel electrodes 331, 333, and 335 are transferred to each green storage region 203, 205, and 207 through each wiring or each contact plug 311, 313, and 315.

A common electrode 350 is formed on or over the photoelectric conversion region 340 of an organic material. The common electrode 350 supplies a bias voltage to the photoelectric conversion region 340 of an organic material. The common electrode 350 may be embodied in a transparent electrode, for example, ZnO or ITO. The common electrode 350 may be embodied in a pixel electrode film. A green pixel G includes a pixel electrode 331, the photoelectric conversion region 340 of an organic material, and the common electrode 350. The green pixel G is defined by the pixel electrode 331.

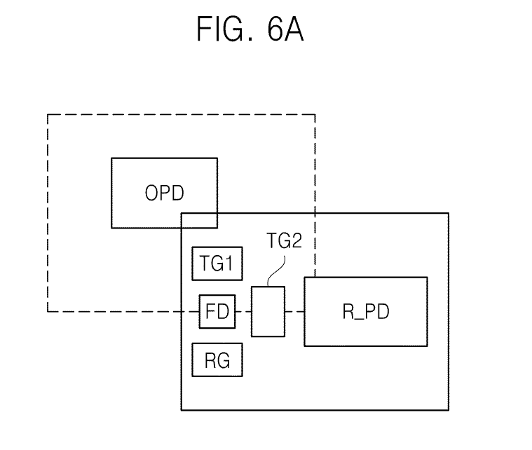

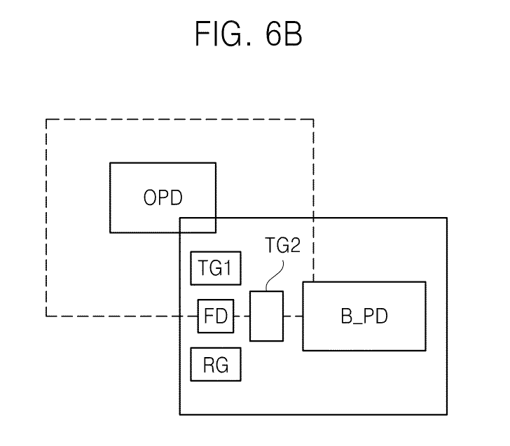

FIG. 6A may be a top view of a green pixel and a red pixel which are partially overlapped with each other, FIG. 6B may be a top view of the green pixel and a blue pixel which are partially overlapped with each other, and FIG. 7 is a detailed diagram of a semiconductor substrate and a circuit region illustrated in FIG. 5.

In FIGS. 6A and 6B, OPD corresponds to the photoelectric conversion region 340 of an organic material, i.e., a photodiode of an organic material, B_PD corresponds to a blue photoelectric conversion region 201, i.e., a photodiode defined by the blue photoelectric conversion region 201, and R_PD corresponds to a red photoelectric conversion region 202, i.e., a photodiode defined by the red photoelectric conversion region 202.

In FIGS. 6A, 6B, and 7, FD is a floating diffusion region, each of TG1, TG2, TG3, and TG4 represents a transfer transistor, i.e., a gate electrode of a transfer gate, and RG represents a reset transistor, i.e., a gate electrode of a reset gate. For example, a green pixel including OPD and a blue pixel including B_PD may share the floating diffusion region FD. Moreover, the green pixel including the OPD and the red pixel including the R_PD may share the floating diffusion region FD. The floating diffusion region FD may be embodied in the semiconductor substrate 200, and TG1, TG2, TG3, and TG4 may be embodied in the circuit region 300.

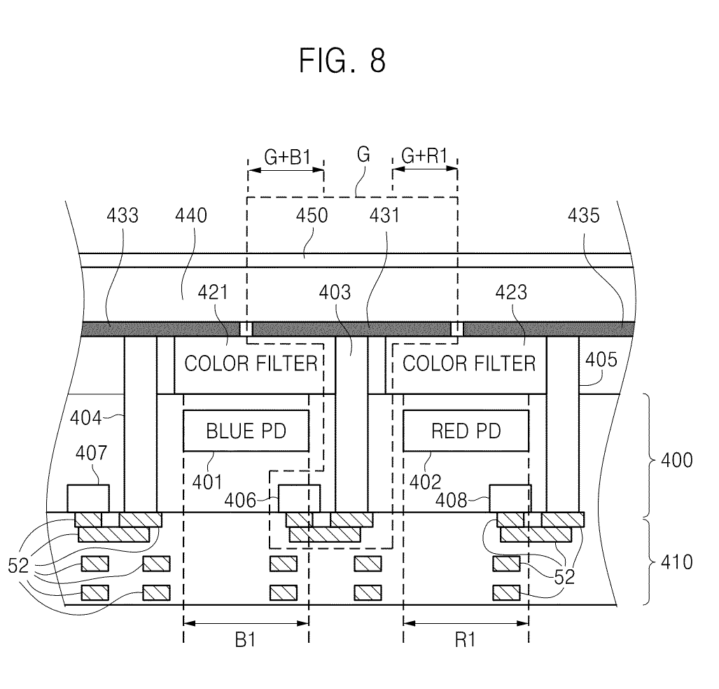

FIG. 8 is a cross-sectional view of the image sensor of FIG. 2 embodied in a back side illumination (BSI) method, which is taken along line V-V′. Referring to FIGS. 1A, 2, and 8, a blue photoelectric conversion region (PD) 401, a red photoelectric conversion region (PD) 402, and a plurality of green storage regions 406, 407, and 408 are formed in a semiconductor substrate 400.

Each of the plurality of green storage regions 406, 407, and 408 performs a function of accumulating electric charges transferred through each contact plug 403, 404, and 405 which may be formed of metal.

Each floating diffusion region corresponding to each region 401, 402, 406, 407, and 408 may be formed in the semiconductor substrate 400. A circuit region 410 may be formed under the semiconductor substrate 400. A gate electrode of each transfer transistor for transferring charges accumulated in each region 401, 402, 406, 407, and 408 to each floating diffusion region may be embodied in the circuit region 410. That is, metal interconnects 52 to transfer the charges accumulated in each of the regions 401, 402, 406, 407, and 408 to a readout circuit are embodied in the circuit region 410.

Color filters 421 and 423 may be formed on or over the semiconductor substrate 400. The color filters 421 and 423 are disposed on a side of the semiconductor substrate 400 which is on an opposite side of circuit region 410. The pixel electrodes 431 and 433 which are separated from each other are formed on or over the blue color filter 421. A blue color filter 421 allows blue wavelengths passing through the pixel electrodes 431 and 433 to pass through the blue photoelectric conversion region 401. The blue photoelectric conversion region 401 performs a photoelectric conversion operation based on the blue wavelengths.

For convenience of description in FIG. 8, it is illustrated that a fifth length of a fifth region where the blue color filter 421 and the pixel electrode 431 are overlapped with each other is the same as a sixth length of a sixth region where the blue color filter 421 and the pixel electrode 433 are overlapped with each other; however, lengths of the fifth region and the sixth region may be different from each other according to an exemplary embodiment.

The pixel electrodes 431 and 435 which are separated from each other are formed on or over the red color filter 423. The red color filter 423 allows red wavelengths passing through the pixel electrodes 431 and 435 to pass through a red photoelectric conversion region 402. The red photoelectric conversion region 402 performs a photoelectric conversion operation based on the red wavelengths.

For convenience of description in FIG. 8, it is illustrated that a seventh length of a seventh region where the red color filter 423 and the pixel electrode 431 are overlapped with each other is the same as an eighth length of an eighth region where the red color filter 423 and the pixel electrode 435 are overlapped with each other; however, lengths of the seventh region and the eighth region may be different from each other according to an exemplary embodiment.

The pixel electrodes 431, 433, and 435 which are separated from each other are formed on or over each of the color filters 421 and 423, respectively. A photoelectric conversion region 440 of an organic material is formed on or over each of the pixel electrodes 431, 433, and 435.

The configuration and the material of the photoelectric conversion region of an organic material in FIG. 5 are substantially the same as a configuration and a material of the photoelectric conversion region 440 of an organic material in FIG. 8, and, thus, repeated descriptions will be omitted.

Each of the pixel electrodes 431, 433, and 435 performs a function of collecting electric charges generated based on green wavelengths in the photoelectric conversion region 440 of an organic material and a function of allowing blue wavelengths and red wavelengths to be passed through. Each of the pixel electrodes 431, 433, and 435 may be embodied in a transparent electrode such as ZnO or ITO. Each of the pixel electrodes 431, 433, and 435 may be embodied in a pixel electrode film. Electric charges collected by each of the pixel electrodes 431, 433, and 435 are transferred to each green storage region 406, 407, and 408 through each wiring or each contact plug 403, 404, and 405.

A common electrode 450 is formed on or over the photoelectric conversion region 440 of an organic material. The common electrode 450 supplies a bias voltage to the photoelectric conversion region 440 of an organic material. The common electrode 450 may be embodied in a transparent electrode such as ZnO or ITO. The common electrode 450 may be embodied in a pixel electrode film. A green pixel G includes the pixel electrode 431, the photoelectric conversion region 440 of an organic material, and the common electrode 450. The green pixel G is defined by the pixel electrode 431.

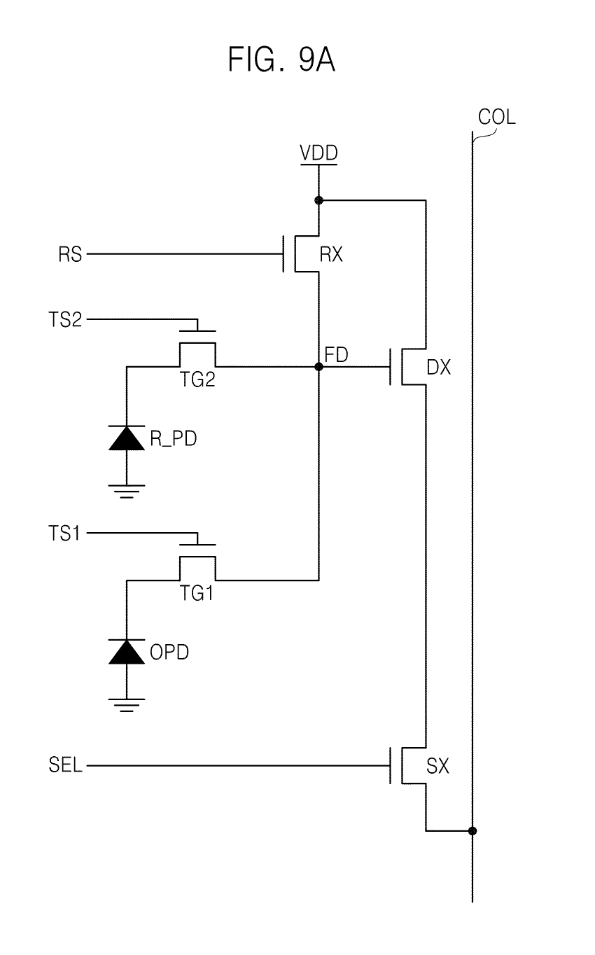

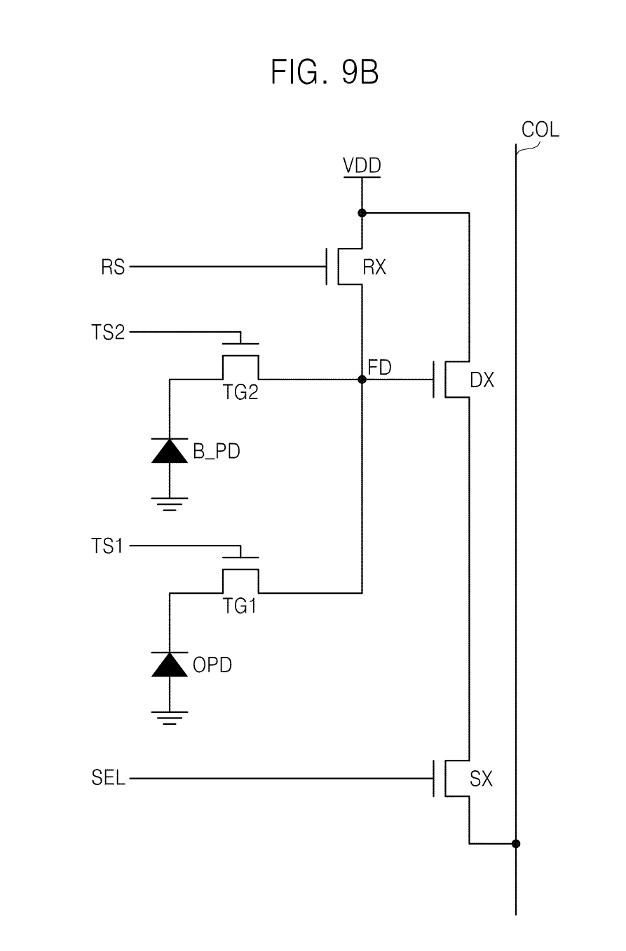

The configurations illustrated in FIGS. 6A, 6B, and 7 may be applied to a configuration of FIG. 8. FIG. 9A is an exemplary embodiment of a readout circuit including a green pixel and a red pixel.

Referring to FIGS. 5 to 9A, OPD and R_PD share one floating diffusion region FD. Moreover, OPD and B_PD share one floating diffusion region FD in another exemplary embodiment, as shown in FIG. 9B. The floating diffusion region FD may be referred to as a floating diffusion node. In terms of pixel, a green pixel and a red pixel share one floating diffusion region FD.

A readout circuit includes two transfer transistors TG1 and TG2, the floating diffusion region FD, a reset transistor RX, a drive transistor DX, and a selection transistor SX.

A first transfer transistor TG1 operates in response to a first transfer control signal TS1, a second transfer transistor TG2 operates in response to a second transfer control signal TS2, the reset transistor RX operates in response to a reset control signal RS, and the selection transistor SX operates in response to a selection signal SEL.

The activation time for the first transfer control signal TS1 and activation time for the second transfer control signal TS2 are appropriately controlled, and a signal corresponding to electric charges generated by OPD and a signal corresponding to electric charges generated by R_PD may be transferred to a column line COL according to an operation of each transistor DX and SX. Here, OPD, R_PD, or B_PD may be embodied in a photo transistor, a photo gate, a pinned photo diode (PPD), or a combination of these.

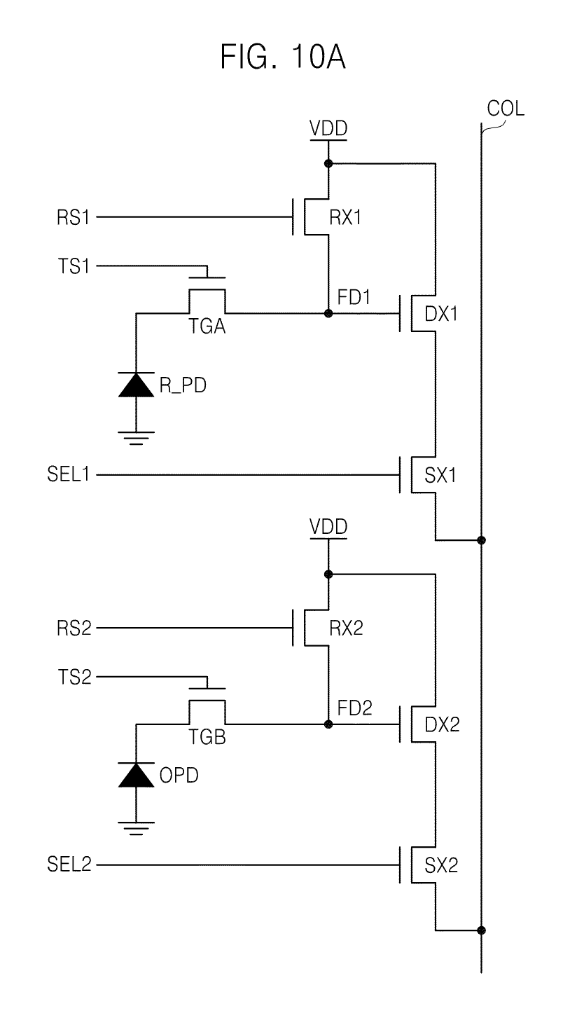

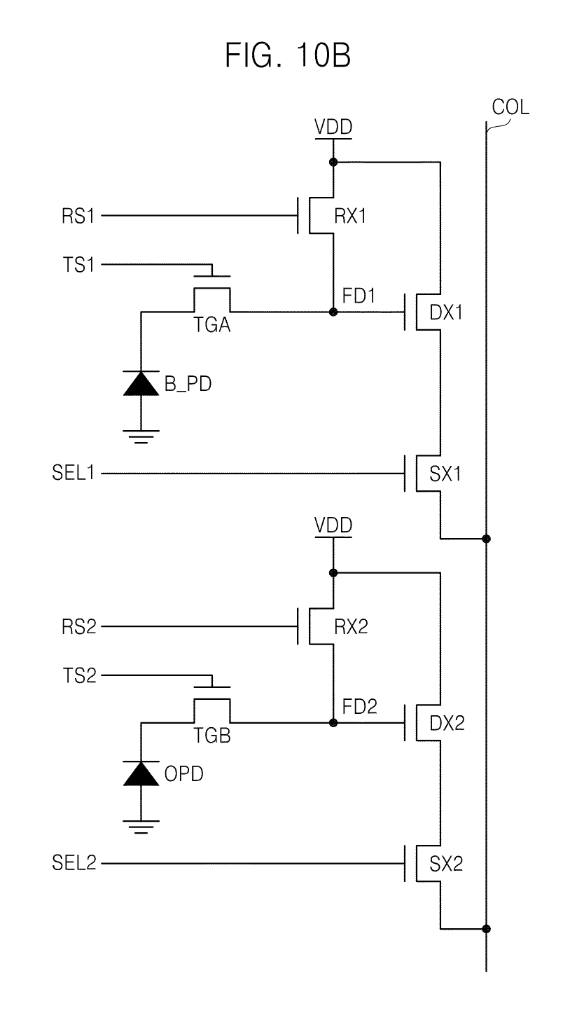

FIGS. 10A and 10B illustrate the readout circuit including a green pixel and a red pixel or a blue pixel, according to an exemplary embodiment. Referring to FIGS. 5, 8, 10A, and 10B, a first readout circuit which reads out the electric charges generated by R_PD (or B_PD) and a second readout circuit which reads out the electric charges generated by OPD are separated from each other.

In terms of pixel, a green pixel and a red pixel (or a green pixel and a blue pixel) are separated from each other. The first readout circuit includes a first transfer transistor TGA, a first floating diffusion region FD1, a first reset transistor RX1, a first drive transistor DX1, and a first selection transistor SX1.

The first transfer transistor TGA operates in response to the first transfer control signal TS1, the first reset transistor RX1 operates in response to a first reset control signal RS1, and the first selection transistor SX1 operates in response to a first selection signal SEL1.

The second readout circuit includes a second transfer transistor TGB, a second floating diffusion region FD2, a second reset transistor RX2, a second drive transistor DX2, and a second selection transistor SX2. The second transfer transistor TGB operates in response to a second transfer control signal TS2, the second reset transistor RX2 operates in response to a second reset control signal RS2, and the second selection transistor SX2 operates in response to a second selection signal SEL2.

The activation time for the first transfer control signal TS1 and activation time for the second transfer control signal TS2 are appropriately controlled, and a signal corresponding to the electric charges generated by OPD and a signal corresponding to the electric charges generated by R_PD (or B_PD) may be transferred to a column line COL according to an operation of each transistor DX1 and SX1, and DX2 and SX2.

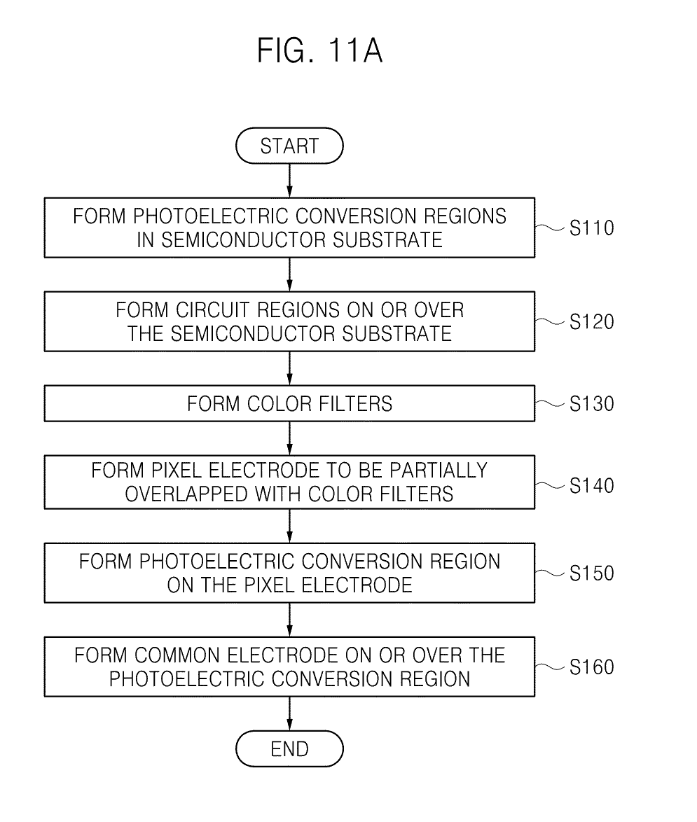

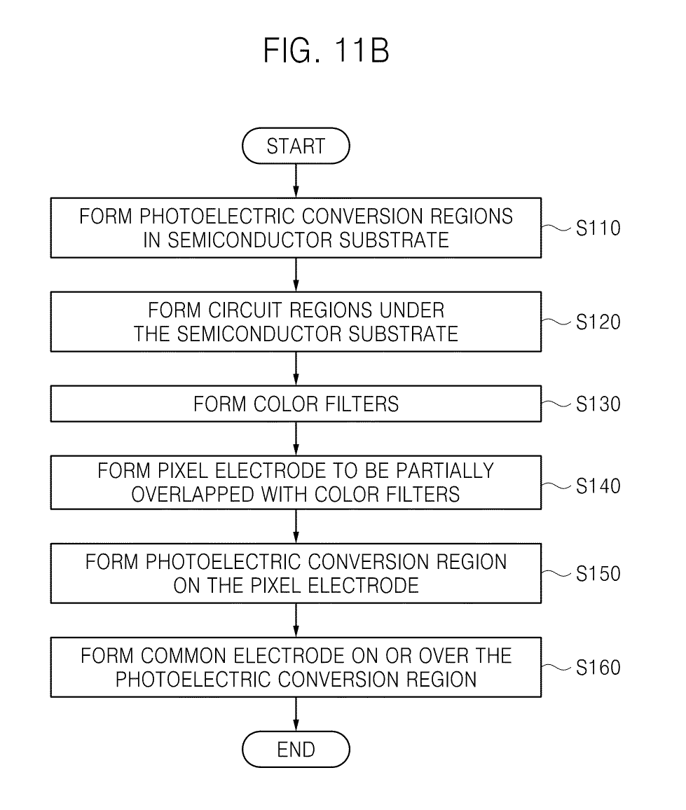

FIGS. 11A and 11B are flowcharts of a method of manufacturing an image sensor according to an exemplary embodiment. A method of manufacturing an image sensor in a FSI method according to an exemplary embodiment will be conceptually described referring to FIGS. 5 and 11A.

The blue photoelectric conversion region 201, the red photoelectric conversion region 202, and the plurality of green storage regions 203, 205, and 207 are formed in the semiconductor substrate 200 (operation 5110). The circuit region 300 is formed on or over the semiconductor substrate 200 (operation S120). The color filters 321 and 323 are formed on or over the circuit region 300 (operation S130). The pixel electrodes 331, 333, and 335 which are separated from each other are formed to be partially overlapped with each of the color filters 321 and 323 (operation S140). The photoelectric conversion region 340 of an organic material is formed on or over each of the pixel electrodes 331, 333, and 335 (operation S150). The common electrode 350 is formed on or over the photoelectric conversion region 340 of an organic material (operation S160).

A method of manufacturing an image sensor in a BSI method according to an exemplary embodiment will be conceptually described referring to FIGS. 8 and 11B.

The blue photoelectric conversion region 401, the red photoelectric conversion region 402, and the plurality of green storage regions 406, 407, and 408 are formed in the semiconductor substrate 400 (operation S110). The circuit region 410 is formed under the semiconductor substrate 400 (operation S120). The color filters 421 and 423 are formed on or over the semiconductor substrate 400 which is on an opposite side of the circuit region 410 (operation S130). Pixel electrodes 431, 433, and 435 which are separated from each other are formed to be partially overlapped with each of the color filters 421 and 423 (operation S140). The photoelectric conversion region 440 of an organic material is formed on or over each of the pixel electrodes 431, 433, and 435 (operation S150). The common electrode 450 is formed on or over the photoelectric conversion region 440 of an organic material (operation S160).

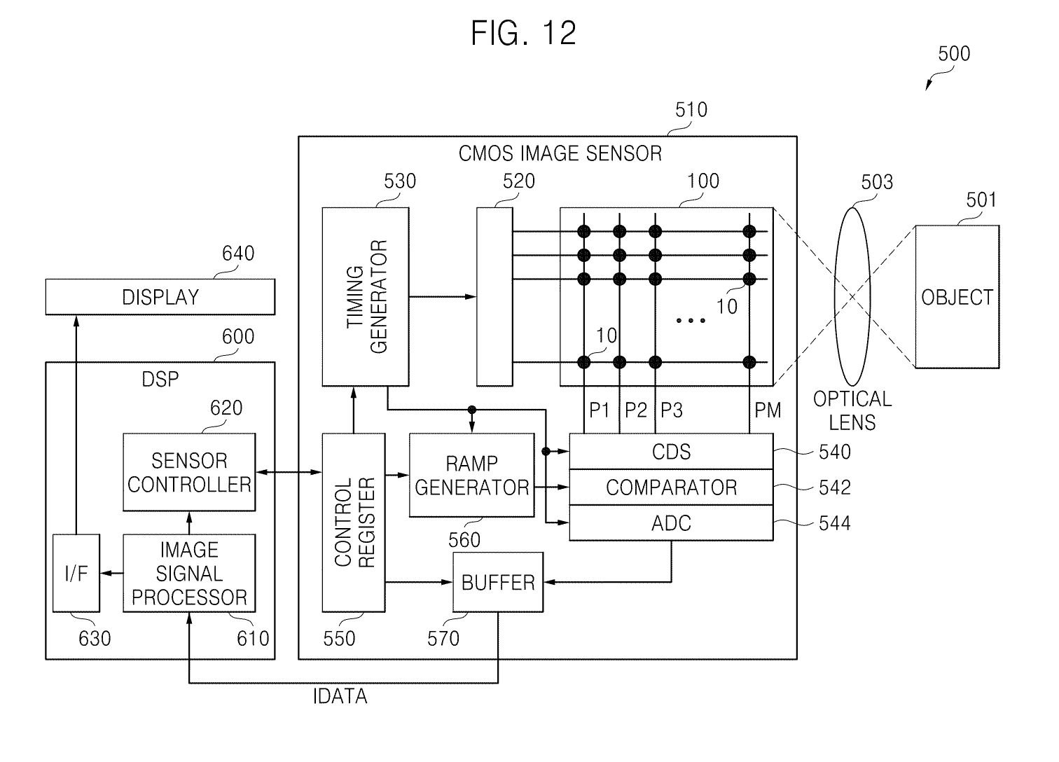

FIG. 12 is a block diagram of an image data processing device including the structure of image sensors of FIG. 1A or 1B. Referring to FIGS. 1A, 1B, and 12, an image data processing device 500 may be embodied in a portable electronic device, such as a digital camera, a camcorder, a mobile phone, a smart phone, a tablet personal computer (PC), an internet of things (IoT) device, an internet of everything (IoE) device, or a wearable computer.

The image data processing device 500 includes an optical lens 503, a CMOS image sensor 510, a digital signal processor (DSP) 600, and a display 640. According to an exemplary embodiment, the image data processing device 500 may omit the optical lens 503. The CMOS image sensor 510 generates image data IDATA for an object 501 incident through the optical lens 503.

The CMOS image sensor 510 includes a pixel array 100, a row driver 520, a timing generator 530, a correlated double sampler (CDS) 540, a comparator 542, and an analog-to-digital conversion (ADC) 544, a control register 550, a ramp signal generator 560, and a buffer 570. The pixel array 100 may include at least one of image sensors 100A, 100A-1, 100B, 100C, and 100D described referring to FIGS. 1A to 4.

A structure of the CMOS image sensor 510 of FIG. 12 is an exemplary embodiment for describing an image data processing device according to an exemplary embodiment.

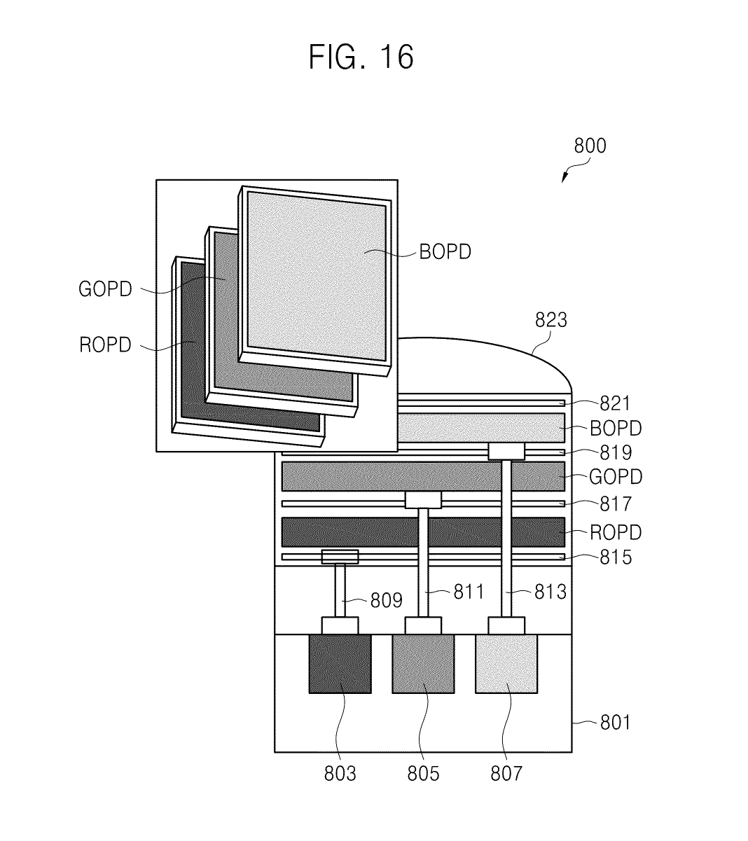

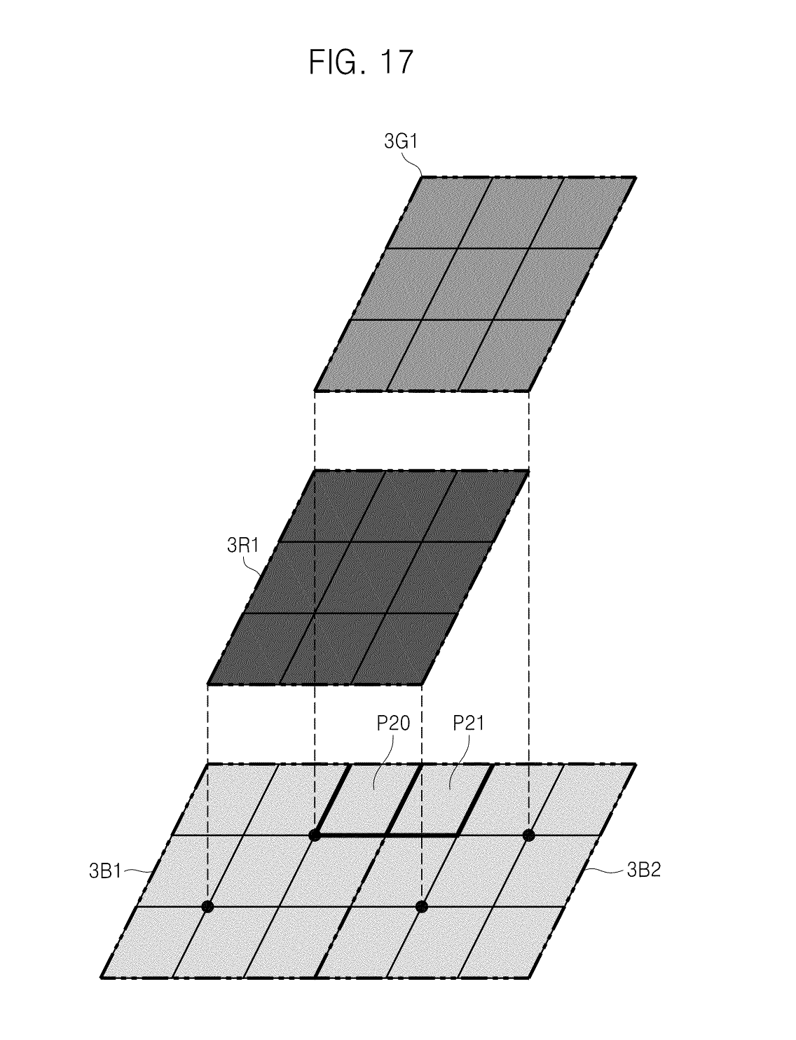

The pixel array 100 includes pixels 10 arranged in a matrix form. As described referring to FIGS. 1A to 11, the pixel array 100 includes a first layer 100BT which includes a plurality of red and blue pixels R and B, and a second layer 100TP which includes a plurality of green pixels G. According to another exemplary embodiment, the pixel array 100 may include a first layer including red organic pixels ROPD, a second layer including green organic pixels GOPD, and a third layer including blue organic pixels BOPD, as illustrated in FIGS. 16 and 17.

For convenience of description in FIG. 16, it is illustrated that the first layer includes the red organic pixels ROPD, the second layer includes the green organic pixels GOPD, and the third layer includes the blue organic pixels BOPD; however, this is not limiting, and an order of embodying each layer may be changed according to exemplary embodiments. That is, as illustrated in FIG. 17, blue organic pixels 3B1 and 3B2 may be embodied in the first layer, red organic pixels 3R1 may be embodied in the second layer, and green organic pixels 3G1 may be embodied in the third layer.

A row driver 520 drives at least two control signals of TS1, TS2, RS, RS1, RS2, SEL, SEL1, and SEL2 for controlling an operation of each of the pixels 10 according to a control of a timing generator 530. The timing generator 530 controls an operation of the row driver 520, the CDS 540, the ADC 544, and the ramp signal generator 560 according to a control of a control register 550.

The CDS 540 performs a correlated double sampling on a pixel signal P1, P2, and P3 to Pm, where m is a natural number, output from each of a plurality of column lines of the pixel array 100. The comparator 542 compares each of a plurality of correlated double sampled pixel signals output from the CDS 540 with a ramp signal output from the ramp signal generator 560, and outputs a plurality of comparison signals.

The ADC 544 converts each of the plurality of comparison signals output from the comparator 542 into a digital signal, and outputs a plurality of digital signals to a buffer 570. The control register 550 controls an operation of the timing generator 530, the ramp signal generator 560, and the buffer 570 according to a control of a digital signal processor 600. The buffer 570 transfers image data IDATA corresponding to the plurality of digital signals output from the ADC 544 to the digital signal processor 600.

The digital signal processor 600 includes an image signal processor 610, a sensor controller 620, and an interface (I/F) 630. The image signal processor 610 controls the sensor controller 620, which controls the control register 550, and the interface 630. According to an exemplary embodiment, the CMOS image sensor 510 and the digital signal processor 600 may be embodied in one package, e.g., in a multi-chip package. According to another exemplary embodiment, the CMOS image sensor 510 and the image signal processor 610 may be embodied in one package, e.g., in a multi-chip package.

The image signal processor 610 processes the image data IDATA transferred to the buffer 570, and transfers processed image data to the interface 630. The image signal processor 610 may generate each data for an overlapped area by using each of signals corresponding to the image data and a ratio for the overlapped area.

For example, the overlapped area may be an area of each region 11, 12, 13, and 14 illustrated in FIG. 2. For example, a ratio for the overlapped area may be a ratio of an overlapping area of a pixel G to an area of a pixel B1. For example, when a skew is 50%, and a pixel G and a pixel B1 are overlapped, a ratio of the overlapping area of a pixel G to the area of a pixel B1, i.e., a ratio for the overlapped area, may be ¼.

In a similar manner, the overlapped area may be an area of each region 21, 22, 23, and 24 illustrated in FIG. 3. For example, the ratio for an overlapped area may be a ratio of an overlapped area of a pixel R to an area of a pixel G1. For example, when a skew is 50%, and the pixel G1 and the pixel R are overlapped, a ratio of an overlapped area of an overlapped area of the pixel R to an area of the pixel G1 may be ¼.

For example, the image signal processor 610 may generate RGB data for an overlapped portion 11, i.e., overlapped area 11, in a following method.

The green data G11 for the overlapped portion 11 can be calculated as shown in Equation 1.

G11=PG/4, [Equation 1]

where PG represents image data corresponding to a signal output from a green pixel G.

The blue data B11 for the overlapped portion 11 can be calculated as shown in Equation 2.

B11=PB1/4 [Equation 2]

where PB1 represents image data corresponding to a signal output from the blue pixel B1.

Red data R11 for the overlapped portion 11 can be calculated as shown in Equation 3.

R11=AVE(PR1/4,PR2/4), [Equation 3]

where AVE represents a function for calculating an average value,
PR1 represents image data corresponding to an output signal of the red pixel R1, and
PR2 represents image data corresponding to an output signal of the red pixel R2.

In some cases, each data PG, PB1, PR1, and PR2 may be referred to as a signal output from each pixel G, B1, R1, and R2.

The image signal processor 610 may generate RGB data for an overlapped portion 12, i.e., an overlapped area 12, in a following method. For example, a ratio for the overlapped area 12 may be defined in a similar manner as the ratio for the overlapped area 11.

Green data G12 for the overlapped portion 12 can be calculated as shown in Equation 4.

G12=PG/4 [Equation 4]

Red data R12 for the overlapped portion 12 can be calculated as shown in Equation 5.

R12=PR1/4, [Equation 5]

where PR1 represents image data corresponding to a signal output from the red pixel R1.

Blue data B12 for the overlapped portion 12 can be calculated as shown in Equation 6.

B12=AVE(PB1/4,PB2/4), [Equation 6]

where PB1 represents image data corresponding to an output signal of the blue pixel B1, and
PB2 represents image data corresponding to an output signal of the blue pixel B2.

The image signal processor 610 may generate RGB data for an overlapped portion 13, i.e., an overlapped area 13, in a following method. For example, a ratio for the overlapped area 13 may be defined in a similar manner as the ratio for the overlapped area 11.

Green data G13 for the overlapped portion 13 can be calculated as shown in Equation 7.

G13=PG/4 [Equation 7]

Red data R13 for the overlapped portion 13 can be calculated as shown in Equation 8.

R13=PR2/4, [Equation 8]

where PR2 represents image data corresponding to a signal output from the red pixel R2.

Blue data B13 for the overlapped portion 13 can be calculated as shown in Equation 9.

B13=AVE(PB1/4,PB2/4) [Equation 9]

The image signal processor 610 may generate RGB data for an overlapped portion 14, i.e., an overlapped area 14, in a following method. For example, a ratio for the overlapped area 14 may be defined in a similar manner as the ratio for the overlapped area 11.

Green data G14 for the overlapped area 14 can be calculated as shown in Equation 10.

G14=PG/4 [Equation 10]

Blue data B14 for the overlapped portion 14 can be calculated as shown in Equation 11.

B14=PB2/4, [Equation 11]

where PB2 represents image data corresponding to a signal output from the blue pixel B2.

Red data R14 for the overlapped portion 14 can be calculated as shown in Equation 12.

R14=AVE(PR1/4,PR2/4) [Equation 12]

However, when the skew is greater than 0% and equal to or less than 50%, the image signal processor 610 may generate RGB data for the overlapped portion 11, e.g., the overlapped area 11, in a following method.

Green data G11 for the overlapped portion 11 can be calculated as shown in Equation 13.

G11=(PG*OR11)/GA, [Equation 13]

where PG represents image data corresponding to a signal output from the green pixel G,
OR11 represents an overlapped area between the green pixel G and the blue pixel B1, and
GA represents an area of the green pixel G.

For example, when an area of the blue pixel B1 is equal to an area of the green pixel G, a ratio for an overlapped area may be determined by OR11/GA. However, even if the area of the blue pixel B1 is different from the area of the green pixel G, the ratio for an overlapped area may be determined by OR11/GA. According to exemplary embodiments, the ratio for an overlapped area may be defined as OR11/GA or a value which is obtained by dividing the overlapped area 11 between the green pixel G and the blue pixel B11 by the area of the blue pixel B1.

Blue data B11 for the overlapped portion 11 may be calculated as shown in Equation 14.

B11=(PB1*OR11)/B1A, [Equation 14]

where PB1 represents image data corresponding to a signal output from the blue pixel B1,
OR11 represents an overlapped area between the green pixel G and the blue pixel B1, and
B1A represents the area of the blue pixel B1.

Red data R11 for the overlapped portion 11 can be calculated as shown in Equation 15.

R11=AVE((PR1*OR12)/R1A,(PR2*OR13)/R2A), [Equation 15]

where AVE represents a function for calculating an average value,
PR1 represents image data corresponding to a signal output from the red pixel R1,
OR12 represents an overlapped area between the red pixel R1 and the green pixel G,
R1A represents an area of the red pixel R1,
PR2 represents image data corresponding to a signal output from the red pixel R2,
OR13 represents an overlapped area between the red pixel R2 and the green pixel G, and
R2A represents an area of the red pixel R2.

When the skew is greater than 0%, and equals to or less than 50%, the image signal processor 610 may generate RGB data for the overlapped portion 12, i.e., the overlapped area 12, in a following method.

Green data G12 for the overlapped portion 12 can be calculated as shown in Equation 16.

G12=(PG*OR12)/GA, [Equation 16]

where PG represents image data corresponding to a signal output from the green pixel G,
OR12 represents an overlapped area between the green pixel G and the red pixel R1, and
GA represents the area of the green pixel G.

Red data R12 for the overlapped portion 12 can be calculated as shown in Equation 17.

R12=(PR1*OR12)/R1A, [Equation 17]

where PR1 represents image data corresponding to a signal output from the red pixel R1,
OR12 represents an overlapped area between the green pixel G and the red pixel R1, and
R1A represents the area of the red pixel R1.

Blue data B12 for the overlapped portion 12 can be calculated as shown in Equation 18.

B12=AVE((PB1*OR11)/B1A,(PB2*OR14)/B2A), [Equation 18]

where PB1 represents image data corresponding to a signal output from the blue pixel B1,
OR11 represents an overlapped area between the blue pixel B1 and the green pixel G,
B1A represents an area of the blue pixel B1,
PB2 represents image data corresponding to a signal output from the blue pixel B2,
OR14 represents an overlapped area between the blue pixel B2 and the green pixel G, and
B2A represents an area of the blue pixel B2.

When the skew is greater than 0%, and equals to or less than 50%, the image signal processor 610 may generate RGB data for the overlapped portion 13, i.e., the overlapped area 13, in a following method.

Green data G13 for the overlapped portion 13 can be calculated as shown in Equation 19.

G13=(PG*OR13)/GA, [Equation 19]

where PG represents image data corresponding to a signal output from the green pixel G,
OR13 represents an overlapped area between the green pixel G and the red pixel R2, and
GA represents the area of the green pixel G.

Red data R13 for the overlapped portion 13 can be calculated as shown in Equation 20.

R13=(PR2*OR13)/R2A, [Equation 20]

where PR2 represents image data corresponding to a signal output from the red pixel R2,
OR13 represents an overlapped area between the green pixel G and the red pixel R2, and
R2A represents the area of the red pixel R2.

Blue data B13 for the overlapped portion 13 can be calculated as shown in Equation 21.

B13=AVE((PB1*OR11)/B1A,(PB2*OR14)/B2A) [Equation 21]

When the skew is greater than 0%, and equals to or less than 50%, the image signal processor 610 may generate RGB data for an overlapped portion 14, i.e., an overlapped area 14, in a following method.

Green data G14 for the overlapped portion 14 can be calculated as shown in Equation 22.

G14=(PG*OR14)/GA, [Equation 22]

where OR14 represents an overlapped area between the green pixel G and the blue pixel B2, and
GA represents the area of the green pixel G.

Blue data B14 for the overlapped portion 14 can be calculated as shown in Equation 23.

B14=(PB2*OR14)/B2A [Equation 23]

Red data R14 for the overlapped portion 14 can be calculated as shown in Equation 24.

R14=AVE((PR1*OR12)/R1A,(PR2*OR13)/R2A) [Equation 24]

The image signal processor 610 may correct each data calculated according to Equations 13 to 24 to be each data corresponding to a reference ratio for a reference overlapped area. Here, the reference ratio for a reference overlapped area may be a ratio for an overlapped area when the skew is 50%.

The sensor controller 620 generates various control signals for controlling the control register 550 according to a control of the image signal processor 610. The interface 630 transfers image data processed by the image signal processor 610 to the display 640.

The display 640 displays image data output from the interface 630. The display 640 may include at least one of a thin film transistor-liquid crystal display (TFT-LCD), a light emitting diode (LED) display, an organic LED (OLED) display, an active-matrix OLED (AMOLED) display, and a flexible display.

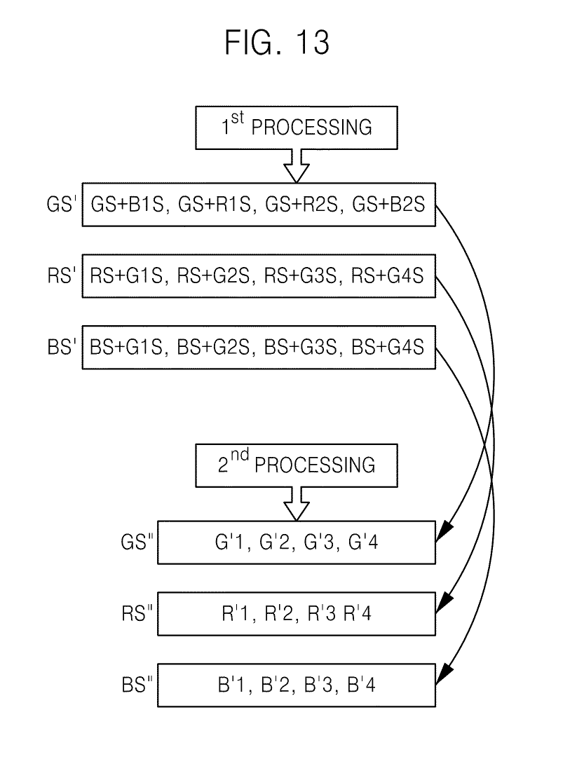

FIG. 13 is a flowchart which describes an operation of the image signal processor which processes image signals output from the structure of the image sensor in FIG. 1A or 1B.

Referring to FIGS. 1A to 13, the image signal processor 610 performs two processing operations. Referring to FIGS. 2, 12, and 13, a method for obtaining each green signal GS' and GS″ will be described. A green image signal output from each overlapped region 11, 12, 13, and 14 may be different from each other according to process, voltage, and temperature (PVT) variations; however, green image signals output from each of the overlapped regions 11, 12, 13, and 14 are assumed to be the same as each other for convenience of description.

In first processing operation, the image signal processor 610 processes (e.g., sequentially outputs) a green image signal GS and a blue image signal B1S output from the overlapped region 11, processes a green image signal GS and a red image signal R1S output from the overlapped region 12, processes a green image signal GS and a red image signal R2S output from the overlapped region 13, and processes a green image signal GS and a blue image signal B2S output from the overlapped region 14.

The first processing operation for an output signal(s) for each of the overlapped regions 11, 12, 13, and 14 may be performed at the same time or at different time.

In second processing operation, the image signal processor 610 calculates a green signal G′1 by interpolating the green image signal GS and the blue image signal B1S, calculates a green signal G′2 by interpolating the green image signal GS and the red image signal R1S, calculates a green signal G′3 by interpolating the green image signal GS and the red image signal R2S, and calculates a green signal G′4 by interpolating the green image signal GS and the blue image signal B2S. The second processing operation, e.g., interpolation, for an output signal(s) of each of the overlapped regions 11, 12, 13, and 14 may be performed at the same time or at different time.

Referring to FIGS. 3, 12, and 13, a method for obtaining each red signal RS' and RS″ will be described. The green image signals output from each overlapped region 21, 22, 23, and 24 may be different from each other according to the PVT variation; however, red image signals RS output from each of the overlapped regions 21, 22, 23, and 24 are assumed to be the same as each other for convenience of description.

In first processing operation, the image signal processor 610 processes a red image signal RS and a green image signal G1S output from the overlapped region 21, processes a red image signal RS and a green image signal G2S output from the overlapped region 22, processes a red image signal RS and a green image signal G3S output from the overlapped region 23, and processes a red image signal RS and a green image signal G4S output from the overlapped region 24.

The first processing operation for an output signal(s) of each of the overlapped regions 21, 22, 23, and 24 may be performed at the same time or at different time.

In second processing operation, the image signal processor 610 calculates a red signal R′1 by interpolating the red image signal RS and the green image signal G1S, calculates a red signal R′2 by interpolating the red image signal RS and the green image signal G2S, calculates a red signal R′3 by interpolating the red image signal RS and the green image signal G3S, and calculates a red signal R′4 by interpolating the red image signal RS and the green image signal G4S.

The second processing operation, e.g., interpolation, for an output signal(s) of each of the overlapped regions 21, 22, 23, and 24 may be performed at the same time or at different time.

Referring to FIGS. 4, 12, and 13, a method for obtaining each blue signal BS' and BS″ will be described. Blue image signals output from each overlapped region 31, 32, 33, and 34 may be different from each other according to the PVT variation; however, blue image signals BS output from each of the overlapped regions 31, 32, 33, and 34 are assumed to be the same as each other for convenience of description.

In first processing operation, the image signal processor 610 processes a blue image signal BS and a green image signal G1S output from the overlapped region 31, processes a blue image signal BS and a green image signal G2S output from the overlapped region 32, processes a blue image signal BS and a green image signal G3S output from the overlapped region 33, and processes a blue image signal BS and a green image signal G4S output from the overlapped region 34.

The first processing operation for an output signal(s) of each of the overlapped regions 31, 32, 33, and 34 may be performed at the same time or at different time.

In second processing operation, the image signal processor 610 calculates a blue signal B′1 by interpolating the blue image signal BS and the green image signal G1S, calculates a blue signal B′2 by interpolating the blue image signal BS and the green image signal G2S, calculates a blue signal B′3 by interpolating the blue image signal BS and the green image signal G3S, and calculates a blue signal B′4 by interpolating the blue image signal BS and the green image signal G4S.

The second processing operation, e.g., interpolation, for an output signal(s) of each of the overlapped regions 31, 32, 33, and 34 may be performed at the same time or at different time. For example, G′=GS/4, B′=B1S/4, R′=AVE(R2S/4+R1S/4) can be performed in FIG. 2.

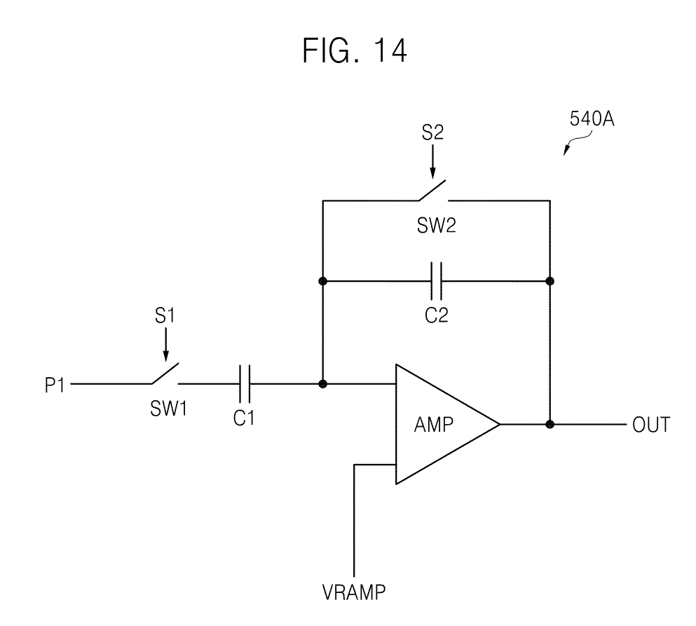

FIG. 14 shows an exemplary embodiment of a correlated double sampling circuit included in the correlated double sampler illustrated in FIG. 12. Referring to FIGS. 12 and 14, the correlated double sampler 540 includes a plurality of correlated double sampling circuits. The plurality of correlated double sampling circuits are substantially the same as each other in structure, so that an operation of a first correlated double sampling circuit 540A which processes a first pixel signal P1 will be described.

The first correlated double sampling circuit 540A includes a plurality of switches SW1 and SW2, a plurality of capacitors C1 and C2, and an amplifier AMP. A first switch SW1 is turned on or off in response to a first switch signal 51 output from the timing generator 530, and a second switch SW2 is turned on or off in response to a second switch signal S2 output from the timing generator 530.

The first switch SW1 is used to transfer the first pixel signal P1 to a first capacitor C1, and the second switch SW2 is used to reset the amplifier AMP. A gain of the amplifier AMP may be determined according to a ratio (e.g., C2/C1) of capacitance of the first capacitor C1 to capacitance of a second capacitor C2.

The amplifier AMP amplifies a difference between an output signal of the first capacitor C1 and a ramp signal Vramp of the ramp signal generator 560, and outputs an amplified signal OUT to the comparator 542. According to an exemplary embodiment, the ratio of the capacitance of the first capacitor C1 to the capacitance of the second capacitor C2 may be determined according to the skew or a ratio for an overlapped area. For example, when the skew is not 50%, the ratio may be adjusted to output a signal corresponding to a 50% skew.

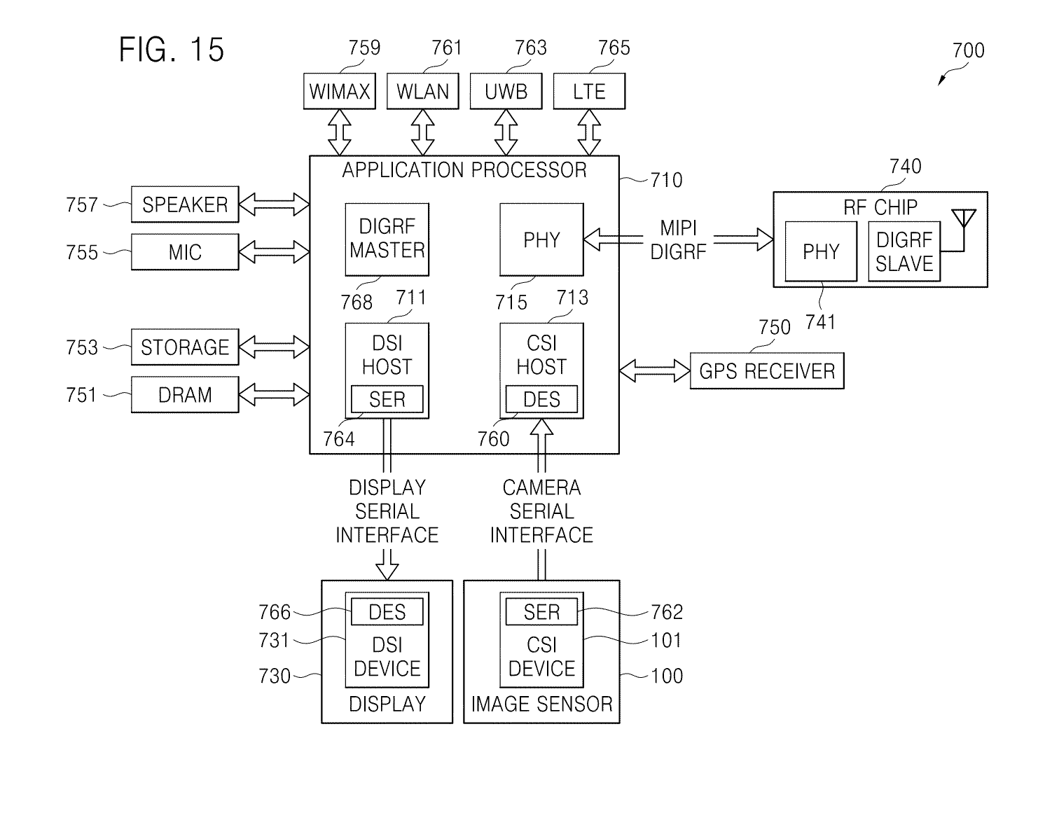

FIG. 15 is a block diagram of a portable electronic device including the structure of image sensors of FIG. 1A or 1B. Referring to FIGS. 1A, 1B, and 15, a portable electronic device 700 may be embodied in a portable electronic device which may use or support a mobile industry processor interface (MIPI®).

The portable electronic device 700 may be embodied in a laptop computer, a personal digital assistant (PDA), a portable media player (PMP), a mobile phone, a smart phone, a tablet PC, a wearable computer, an IoT device, an IoE device, or a digital camera. The portable electronic device 700 includes an application processor (AP) 710, an image sensor 100, and a display 730.

A camera serial interface (CSI) host 713 embodied in the AP 710 may perform a serial communication with a CSI device 101 of the image sensor 100 through a camera serial interface (CSI). For example, the CSI host 713 may perform the same or a similar function as the image signal processor 610 illustrated in FIG. 12. According to an exemplary embodiment, the CSI host 713 may include a de-serializer (DES) 760, and the CSI device 101 may include a serializer (SER) 762.

The image sensor 100 may include the image sensor described above referring to FIGS. 1 to 10.

A display serial interface (DSI) host 711 embodied in the AP 710 may perform a serial communication with a DSI device 731 of the display 730 through a display serial interface. According to an exemplary embodiment, the DSI host 711 may include a serializer (SER) 764, and the DSI device 731 may include a de-serializer (DES) 766. The de-serializer and the serializer may process an electrical signal or an optical signal, respectively.

The portable electronic device 700 may further include a radio frequency (RF) chip 740 which may communicate with the AP 710 which may include DigRF^{SM} master 768. A physical layer (PHY) 715 of the AP 710 and a PHY 741 of the RF chip 740 may transmit or receive data to or from each other according to MIPI DigRF. The portable electronic device 700 may further include a GPS receiver 750, a memory 751 such as a dynamic random access memory (DRAM), a data storage device 753 which is embodied in a non-volatile memory such as a NAND flash memory, a microphone (MIC) 755, or a speaker 757.

The portable electronic device 700 may communicate with an external device using at least one of communication protocols, e.g., worldwide interoperability for microwave access (WiMAX) 759, a Wireless LAN (WLAN) 761, an ultra-wideband (UWB) 763 and a long term evolution (LTE)™ 765.

The image data processing device 700 may communicate with an external device using Bluetooth or WiFi.

FIG. 16 is a schematic cross-sectional view of an image sensor including three stacked organic pixels. Referring to FIG. 16, an image sensor 800 may include three stacked red, green, and blue organic pixels ROPD, GOPD and BOPD. For example, a skew between a red organic pixel ROPD embodied in a first layer and a green organic pixel GOPD embodied in a second layer is 33.3%, and a skew between the green organic pixel GOPD embodied in the second layer and a blue organic pixel BOPD embodied in a third layer may be 33.3%.

A red storage region 803, a green storage region 805, a blue storage region 807 are embodied in a semiconductor substrate 801. The red storage region 803 performs a function of accumulating electric charges transferred through a contact plug 809. The green storage region 805 performs a function of accumulating electric charges transferred through a contact plug 811. The blue storage region 807 performs a function of accumulating electric charges transferred through a contact plug 813. The contact plugs 809, 811, and 813 may be formed of a metal or of a conducting material.

The red organic pixel ROPD performs a photoelectric conversion operation based on red wavelengths input through a microlens 823, and generates electric charges according to a result of the performance. The generated electric charges are transferred to the red storage region 803 through the contact plug 809. The green organic pixel GOPD performs a photoelectric conversion operation based on the green wavelengths input through the microlens 823, and generates electric charges according to a result of the performance. The generated electric charges are transferred to the green storage region 805 through the contact plug 811. The blue organic pixel BOPD performs a photoelectric conversion operation based on blue wavelengths input through the microlens 823, and generates electric charges according to a result of the performance. The generated electric charges are transferred to the blue storage region 807 through the contact plug 813.

The organic pixels ROPD, GOPD, and BOPD may be the same as or similar in structure to the photoelectric conversion region 340 illustrated in FIG. 5.

The pixel electrode 819 may perform a function of collecting electric charges generated in the blue organic pixel BOPD and a function of allowing green wavelengths and red wavelengths to be passed through. The pixel electrode 817 may perform a function of collecting electric charges generated in the green organic pixel GOPD and a function of allowing red wavelengths and blue wavelengths to be passed through. The pixel electrode 815 may perform a function of collecting electric charges generated in the red organic pixel ROPD and a function of allowing green wavelengths and blue wavelengths to be passed through.

Each of the pixel electrodes 819, 817, and 815 may be embodied in a transparent electrode. For example, each of the pixel electrodes 819, 817, and 815 may be embodied in ZnO or ITO. A common electrode 821 may be formed on or above the blue organic pixel BOPD. The common electrode 821 may supply a bias voltage to each of the organic pixels BOPD, GOPD, and/or ROPD. Each of the organic pixels BOPD, GOPD, and/or ROPD may perform a photoelectric conversion function.

FIG. 17 is a conceptual diagram for describing a processing of output signals of the three stacked organic pixels illustrated in FIG. 16. For convenience of description in FIG. 17, it is assumed that blue organic pixels 3B1 and 3B2 are embodied in a first layer, a red organic pixel 3R1 is embodied in a second layer, and a green organic pixel 3G1 is embodied in a third layer.

A pixel including three stacked organic pixels 3B1, 3R1, and 3G1 may perform a function of the pixel 10 illustrated in FIG. 12.

Referring to FIGS. 12 and 17, each signal output from each of the organic pixels 3B1, 3R1, and 3G1 is processed by CDS 540, comparator 542, ADC 544, and buffer 570, and each image data IDATA generated according to a result of the processing is transferred to the image signal processor 610. The image signal processor 610 may generate RGB data for an overlapped area using each signal corresponding to the image data IDATA and a ratio for the overlapped area.

For example, as shown in FIG. 17, when a skew between the first blue organic pixel 3B1 and the red organic pixel 3R1 is ⅓, and a skew between the red organic pixel 3R1 and the green organic pixel 3G1 is ⅓, the image signal processor 610 may generate RGB data for an overlapped area P20 of three organic pixels 3B1, 3R1, and 3G1 in a following method.

For example, when a skew is ⅓, the first blue organic pixel 3B1 is overlapped with the red organic pixel 3R1 as much as 4/9 of each pixel area, and the first blue organic pixel 3B1 and the green organic pixel 3G1 are overlapped with each other as much as 1/9 of each pixel area. For example, when a skew between the first blue organic pixel 3B1 and the red organic pixel 3R1 is ⅓, and a skew between the red organic pixel 3R1 and the green organic pixel 3G1 is ⅓, each overlapped area P20 and P21 may be 1/9 of an area of each organic pixel 3B1, 3R1, 3G1, and 3B2. That is, a ratio for the overlapped area may be 1/9. The 1/9 may be used as a reference ratio.

Red data RP20 for an overlapped area P20 can be calculated as shown in Equation 25.

RP20=3R1S/9, [Equation 25]

where 3R1S represents image data corresponding to a signal output from the red organic pixel 3R1.

Green data GP20 for the overlapped area P20 can be calculated as shown in Equation 26.

GP20=3G1S/9, [Equation 26]

where 3G1S represents image data corresponding to a signal output from the green organic pixel 3G1.

Blue data BP20 for the overlapped area P20 can be calculated as shown in Equation 27.

RP20=3B1S/9, [Equation 27]

where 3B1S represents image data corresponding to a signal output from the blue organic pixel 3B1.

Red data RP21 for an overlapped area P21 can be calculated as shown in Equation 28.

RP21=3R1S/9, [Equation 28]

where 3R1S represents image data corresponding to a signal output from the red organic pixel 3R1.

Green data GP21 for the overlapped area P21 can be calculated as shown in Equation 29.

GP21=3G1S/9, [Equation 29]

where 3G1S represents image data corresponding to a signal output from the green organic pixel 3G1.

Blue data BP21 for the overlapped area P21 can be calculated as shown in Equation 30.

BP21=3B2S/9, [Equation 30]

where 3B2S represents image data corresponding to a signal output from the blue organic pixel 3B2.

In some cases, each of data 3B1S, 3B2S, 3R1S, and 3G1S can be referred to as a signal output from each organic pixel.

According to an exemplary embodiment, when a skew between the first blue organic pixel 3B1 and the red organic pixel 3R1 is not ⅓, and a skew between the red organic pixel 3R1 and the green organic pixel 3G1 is not ⅓, the image signal processor 610 may correct each RGB data calculated according to Equations 25 to 30 to be each RGB data corresponding to a reference ratio for a reference overlapped area. For example, the reference ratio for a reference overlapped area may be 1/9.

An image sensor according to an exemplary embodiment may generate a high-resolution image which looks like a high resolution image having a reduced size of a pixel without actually reducing a size of the pixel by changing an embodied position of a pixel electrode. Moreover, an image data processing device including the image sensor may effectively separate RGB data from output signals of the image sensor.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An image data processing device comprising:
an image sensor which includes a first pixel disposed in a first layer and a second pixel which is disposed in a second layer and is partially overlapped with the first pixel to form an overlapped area, and is configured to output a first signal from the first pixel and a second signal from the second pixel; and
an image signal processor configured to output a first data for the overlapped area using a ratio for the overlapped area between the first pixel and the second pixel and the first signal, and output a second data for the overlapped area using the ratio and the second signal.

2. The image data processing device of claim 1, wherein the image sensor further includes a third pixel and a fourth pixel included in the first layer, and is configured to further output a third signal and a fourth signal from each of the third pixel and the fourth pixel, respectively, and
the image signal processor is configured to output a third data for the overlapped area using a function of a first value generated by the ratio and the third signal and a second value generated by the ratio and the fourth signal.

3. The image data processing device of claim 2, wherein each of the third pixel and the fourth pixel is partially overlapped with the second pixel.

4. The image data processing device of claim 2, wherein the function is an average value function.

5. The image data processing device of claim 2, wherein, by using a reference ratio for a reference overlapped area between the first pixel and the second pixel and the ratio, the image signal processor is configured to correct the first data, the second data, and the third data to correspond to the reference ratio.

6. The image data processing device of claim 2, wherein the image sensor includes:
a correlated double sampling circuit configured to perform correlated double sampling on the first signal, second signal, third signal, and the fourth signal, adjust a gain of each of the first signal, the second signal, the third signal, and the fourth signal using the ratio, and output the gain-adjusted first, second, third, and fourth signals to the image signal processor.

7. The image data processing device of claim 2, wherein the first pixel is a blue pixel, the second pixel is an organic green pixel, and the third pixel and the fourth pixel are red pixels.

8. The image data processing device of claim 7, wherein the second pixel includes:
a first photoelectric conversion region comprising an organic material;
a first pixel electrode which is partially overlapped with each of the first pixel and the second pixel and collects electric charges generated in the first photoelectric conversion region; and
a common electrode which supplies a bias voltage to the first photoelectric conversion region.

9. An image data processing device comprising:
an image sensor which includes a first pixel disposed in a first layer, a second pixel which is disposed in a second layer and is partially overlapped with the first pixel, and a third pixel which is disposed in a third layer and is partially overlapped with the first pixel and the second pixel to form an overlapped area, and is configured to output a first signal, a second signal, and a third signal from the first pixel, the second pixel, and the third pixel, respectively; and
an image signal processor configured to output a first data for the overlapped area by using a ratio for the overlapped area between the first pixel and the third pixel and the first signal, output a second data for the overlapped area by using the ratio and the second signal, and output a third data for the overlapped area by using the ratio and the third signal.

10. The image data processing device of claim 9, wherein each of the first pixel, the second pixel, and the third pixel is an organic pixel.

11. The image data processing device of claim 9, wherein, by using a reference ratio of a reference overlapped area among the first pixel, the second pixel, and the third pixel and the ratio, the image signal processor is configured to correct each of the first data, the second data, and the third data to correspond to the reference ratio.

12. The image data processing device of claim 9, wherein the image sensor includes:
a correlated double sampling circuit configured to perform correlated double sampling on the first signal, the second signal, and the third signal, adjust a gain of each of the first signal, the second signal, and the third signal, and output the gain-adjusted first, second, and third signals to the image signal processor.

13. A portable electronic device comprising:
an image sensor which includes a first pixel disposed in a first layer and a second pixel which is disposed in a second layer and is partially overlapped with the first pixel to form an overlapped area, and is configured to output a first signal and a second signal from the first pixel and the second pixel, respectively; and
an application processor which includes an image signal processor configured to output a first data for the overlapped area by using a ratio for the overlapped area between the first pixel and the second pixel and the first signal, and output a second data for the overlapped area by using the ratio and the second signal.

14. The portable electronic device of claim 13, wherein, the image sensor further includes a third pixel and a fourth pixel included in the first layer, and is configured to further output a third signal and a fourth signal from the third pixel and the fourth pixel, respectively, and
the image signal processor is configured to output a third data for the overlapped area by using a function of a first value generated by the ratio and the third signal and a second value generated by the ratio and the fourth signal.

15. The portable electronic device of claim 14, wherein the function is an average value function.

16. The portable electronic device of claim 14, wherein, by using a reference ratio for a reference overlapped area between the first pixel and the second pixel and the ratio, the image signal processor is configured to correct each of the first data, the second data, and the third data to correspond to the reference ratio.

17. The portable electronic device of claim 14, wherein the image sensor further includes:
a correlated double sampling circuit configured to perform correlated double sampling on the first signal, the second signal, the third signal, and the fourth signal, adjust a gain of each of the first signal, the second signal, the third signal, and the fourth signal, and output the gain-adjusted first, second, third, and fourth signals to the image signal processor.

18. The portable electronic device of claim 14, wherein the first pixel is a blue pixel, the second pixel is an organic green pixel, and the third pixel and the fourth pixel are red pixels.

19. The portable electronic device of claim 18, wherein the second pixel includes:
a first photoelectric conversion region comprising an organic material;
a first pixel electrode which is partially overlapped with the first pixel and the second pixel, and configured to collect electric charges generated in the first photoelectric conversion region; and
a common electrode configured to supply a bias voltage to the first photoelectric conversion region.

20. The portable electronic device of claim 13, further comprising a camera serial interface connected between the image sensor and the image signal processor.
